(19) United States
(12) Patent Application Publication
(10) Pub. No.: US 2017/0066650 A1
(43) Pub. Date: Mar. 9, 2017

(54) SYNGAS PRODUCTION WITH CYCLIC OXIDATION HEAT SUPPLY

(71) Applicants: Amnon YOGEV, Rechovot (IL); Eliyahu GAMZON, Moshav Beit Oved (IL); Raviv SEGEV, Kiryat Motzkin (IL); ENGINEUITY RESEARCH AND DEVELOPMENT LTD., Yavne (IL)

(72) Inventors: Amnon YOGEV, Rechovot (IL); Eliyahu GAMZON, Moshav Beit Oved (IL); Raviv SEGEV, Kiryat Motzkin (IL)

(21) Appl. No.: 15/308,367

(22) PCT Filed: Apr. 26, 2015
(86) PCT No.: PCT/IL2015/050431

§ 371 Date: Nov. 2, 2016

Related U.S. Application Data
(60) Provisional application No. 61/989,551, filed on May 7, 2014.

(51) Int. Cl. C01B 3/34; C09K 5/16; C09K 5/02; C09K 5/08; B01J 7/00; B01J 19/24

(52) U.S. Cl. CPC C01B 3/344; B01J 7/00; B01J 19/246; C09K 5/02; C09K 5/08; C09K 5/16; C01B 2203/0255; C01B 2203/0838; C01B 2203/1241; B01J 2219/00081

(57) ABSTRACT

Processes and units are provided, which carry out cyclic steps of zinc oxidation and reduction of zinc oxide to combine an exothermic heat delivering step with an endothermic syngas production step, respectively. Both steps use zinc as the pivotal element that enables the process to be carried out cyclically. Heat is delivered from the exothermic step to the endothermic syngas via heat storage elements of various types which are arranged according to the reaction's conditions and characteristic temperatures. Thus, energy efficient syngas production methods and units are provided.

### BACKGROUND OF THE INVENTION

1. Technical Field

The present invention relates to the field of syngas production, and more particularly, to zinc-mediated syngas production.

2. Discussion of Related Art

Adanez et al. 2011 review the “Progress in Chemical-Looping Combustion and Reforming technologies” in Progress in Energy and Combustion Science 38 (2012) 215-282. Syngas production by reacting methane with zinc oxide is an endothermic process, described e.g., in Ebrahimi et al. 2010: “Synthesis gas and zinc production in a noncatalytic packed-bed reactor”, Chemical Engineering & Technology 33(12):1989-1998, in Ebrahim 2011: “New syngas production method based on noncatalytic methane reaction with metal oxides”, chapter 2 in Indarto, A. and Palgunadi J. (eds.): “Syngas: Production, Applications and Environmental Impact”, Nova Publishing Inc., in U.S. Pat. No. 8,366,966 and in U.S. Patent Publication No. 20090114881. The publications listed above are incorporated herein by reference in their entirety.

### SUMMARY OF THE INVENTION

One aspect of the present invention provides a method comprising storing heat produced by oxidation of zinc; using the stored heat to react the produced zinc oxide with methane to form syngas; and re-using zinc reduced by the reaction with methane for the oxidation.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1A-1C, 2 and 3 are high level schematic block diagrams of syngas production units and methods, according to some embodiments of the invention.

FIGS. 4A-4F are high level schematic illustrations of heat storage elements and methods, according to some embodiments of the invention.

FIG. 5 is a high level schematic illustration of a syngas production system, according to some embodiments of the invention.

FIG. 6 is a high level flowchart illustrating methods, according to some embodiments of the invention.

FIGS. 7A-7C are illustrative thermodynamic diagrams illustrating reaction conditions for converting methane to syngas, according to some embodiments of the invention.

### DETAILED DESCRIPTION OF THE INVENTION

Prior to the detailed description being set forth, it may be helpful to set forth definitions of certain terms that will be used hereinafter.

The term “syngas” as used in this application refers to a mixture comprising at least H₂ (hydrogen) and CO (carbon monoxide). The mixture may have different ratios of H₂:CO and may comprise additional gases or vapors.

The term “heat storage element” as used in this application refers to any member or material as well as to combinations thereof, which may be used to store and release heat. The term “heat storage element” as used in this application refers to structural elements such as walls or pipes, to material constructions such as foams or ampules and to materials such as metals, ceramics or salts, as well as to possible combinations thereof.

It is noted that the illustrated flows into and out of chambers and units intrinsically imply that corresponding inlets and outlets (e.g., valve inlets and outlets, possibly controllable) are provided and configured according to the illustrated scheme of flows. Such inlets and outlets are considered to be part of the present disclosure.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

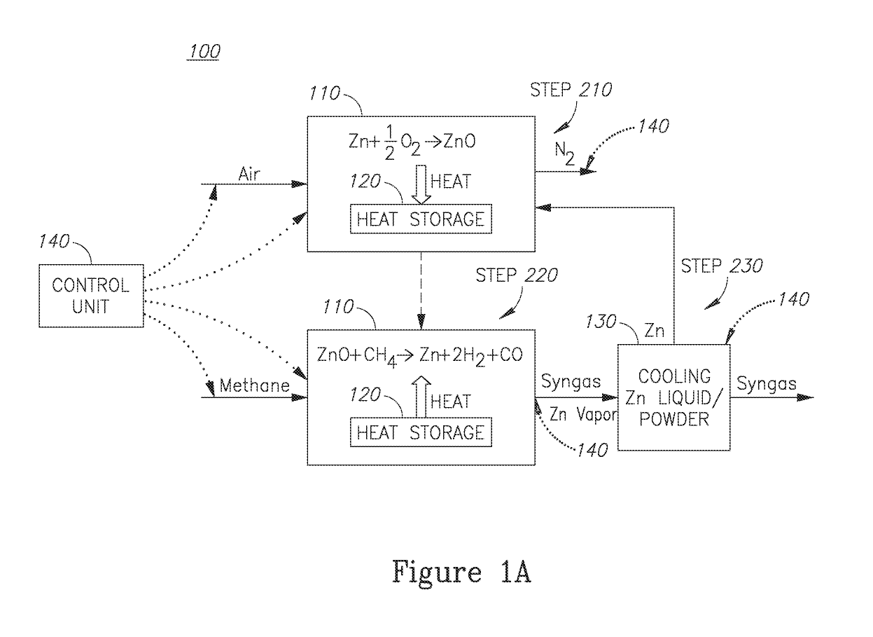

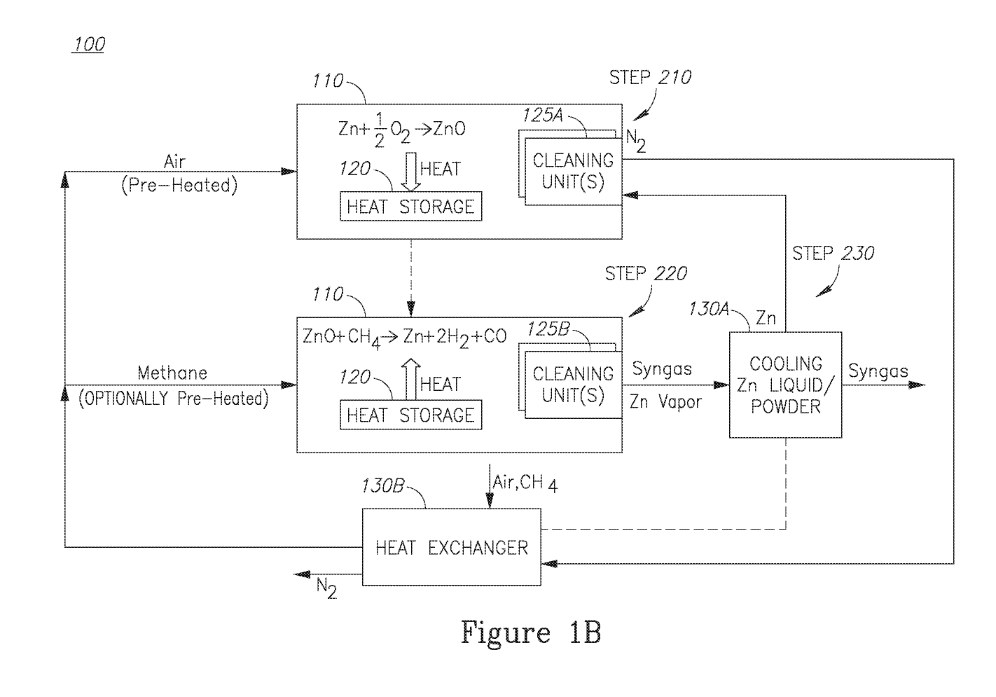

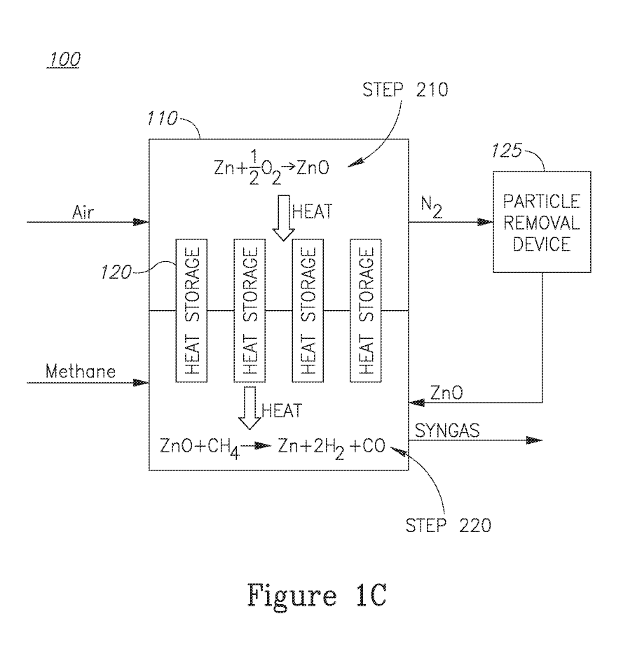

FIGS. 1A-1C, 2 and 3 are high level schematic block diagrams of syngas production units and methods, according to some embodiments of the invention.

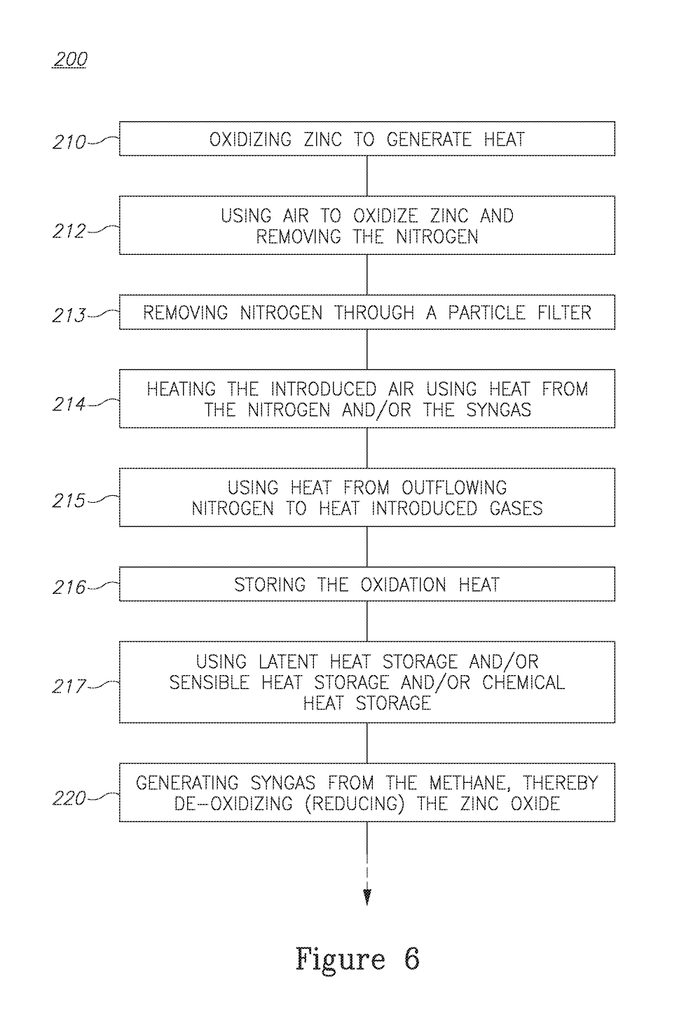

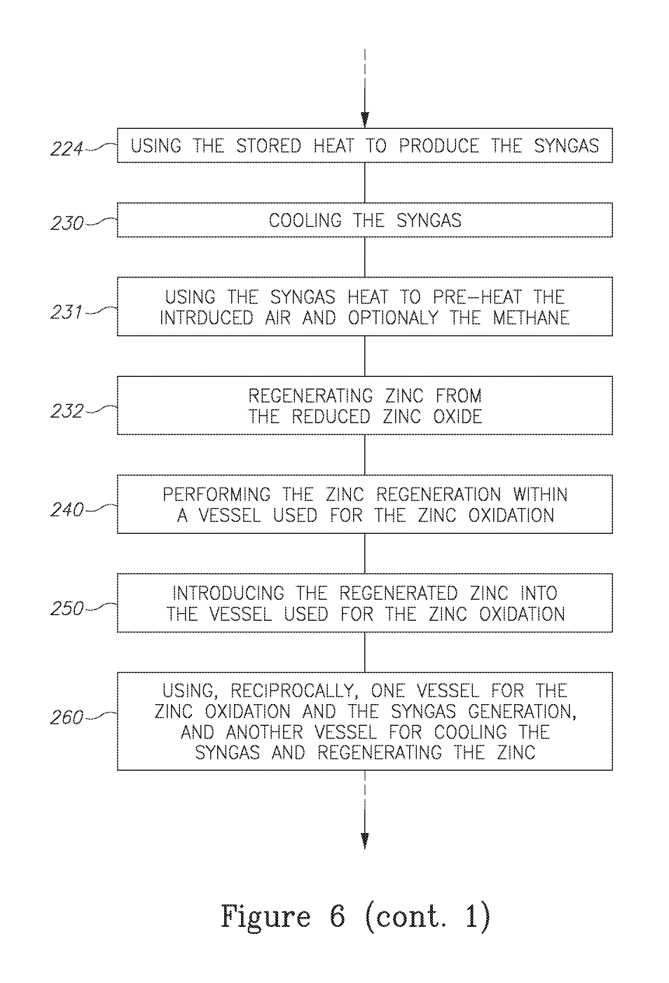

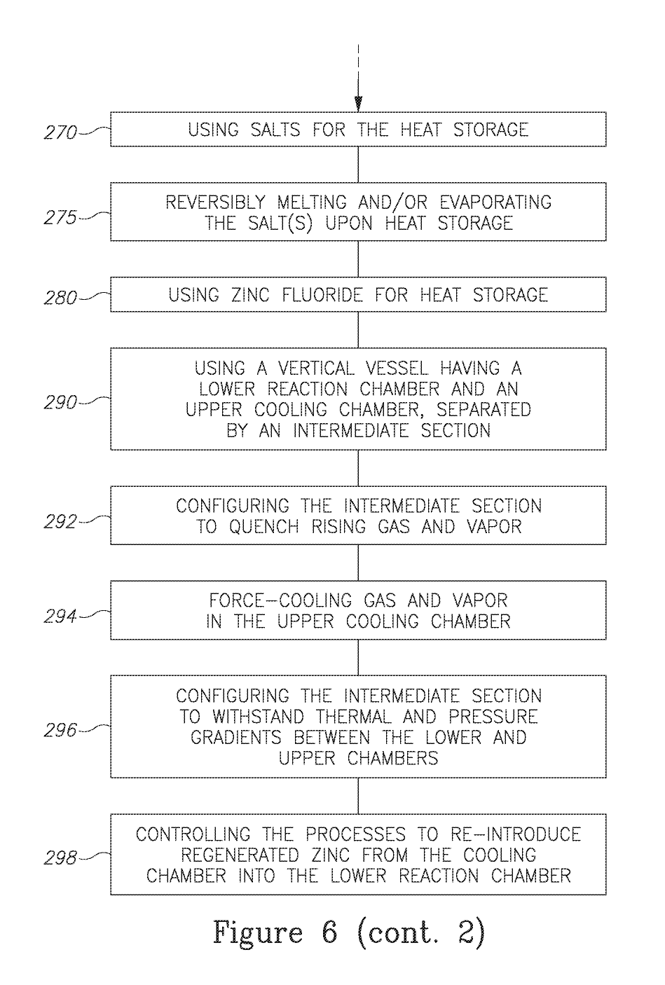

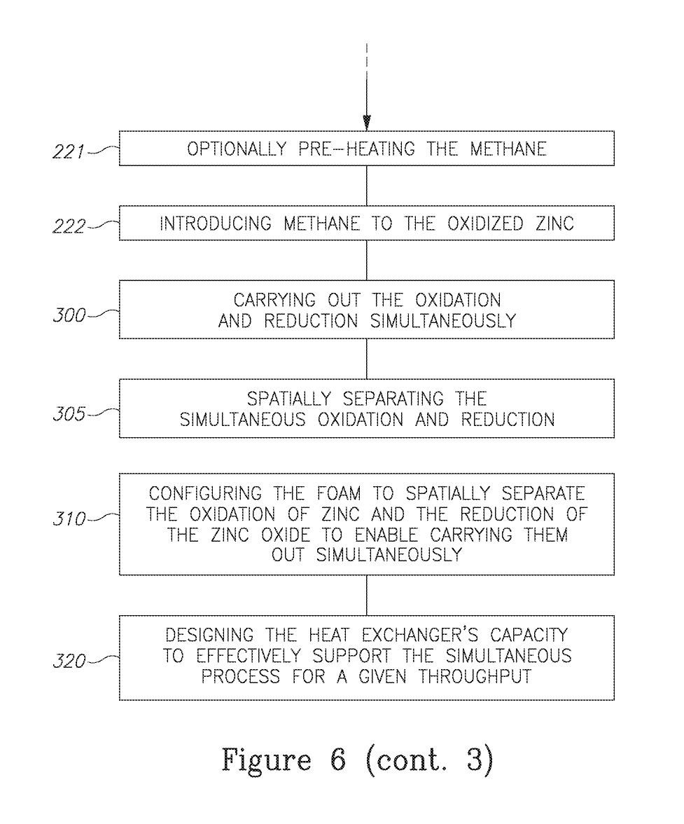

Disclosed syngas production methods (see also method 200 in FIG. 6 below) comprise storing heat produced by oxidation of zinc (Zn+½O₂→ZnO), using the stored heat to react the produced zinc oxide with methane to form syngas (ZnO+CH₄→Zn+2H₂+CO, wherein the term “syngas” is used to represent a mixture comprising at least H₂ and CO) and re-using zinc reduced by the reaction with methane for the oxidation (e.g., regenerating zinc vapor into zinc liquid, and/or powder). The process is thus cyclic, allowing repetitions of zinc oxidation and zinc oxide reduction to be carried out sequentially or in parallel in multiple chambers.

It is noted that the reactions are illustrated schematically, and may comprise additional reactants and/or stages. It is further noted that the oxidation of zinc may be carried out by any oxidation agent; oxidation by oxygen is presented here for illustrative but non-limiting purpose. Oxidation by introduction of air (followed by removal of nitrogen and recuperation of the heat stored in the nitrogen) is a simple exemplary and non-limiting possibility of oxidizing zinc with oxygen in the air. Disclosed syngas production units 100 comprise units configured to carry out the methods. It is noted that in all embodiments, the oxidation may be carried out by air, oxygen-enriched air and/or by oxygen.

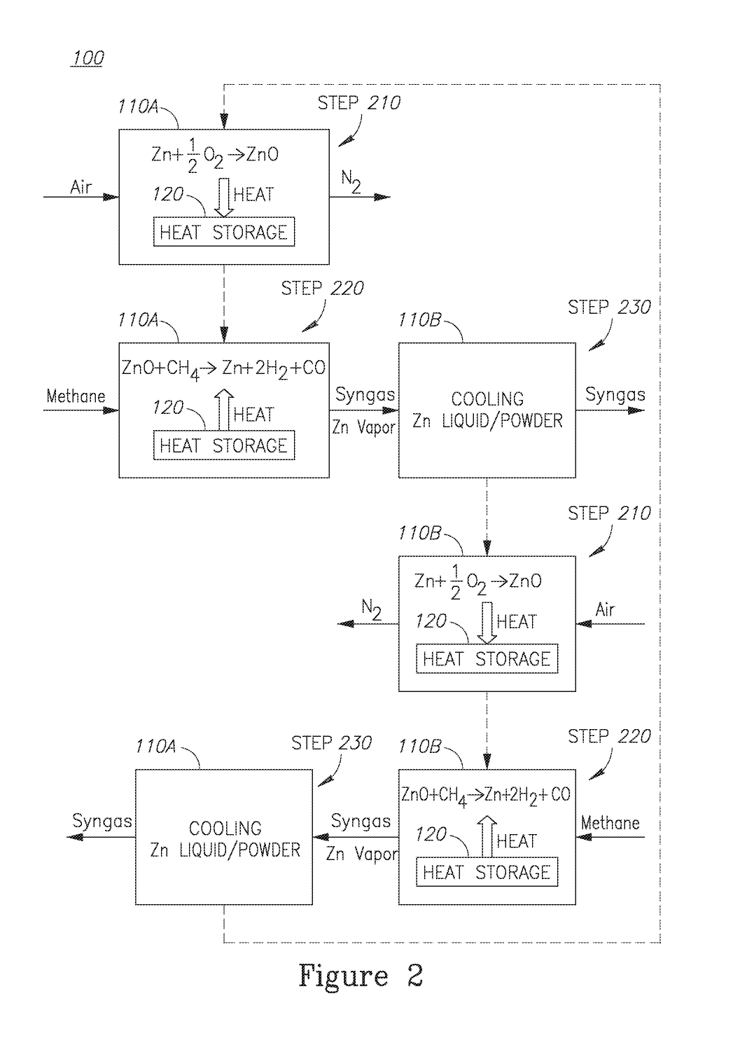

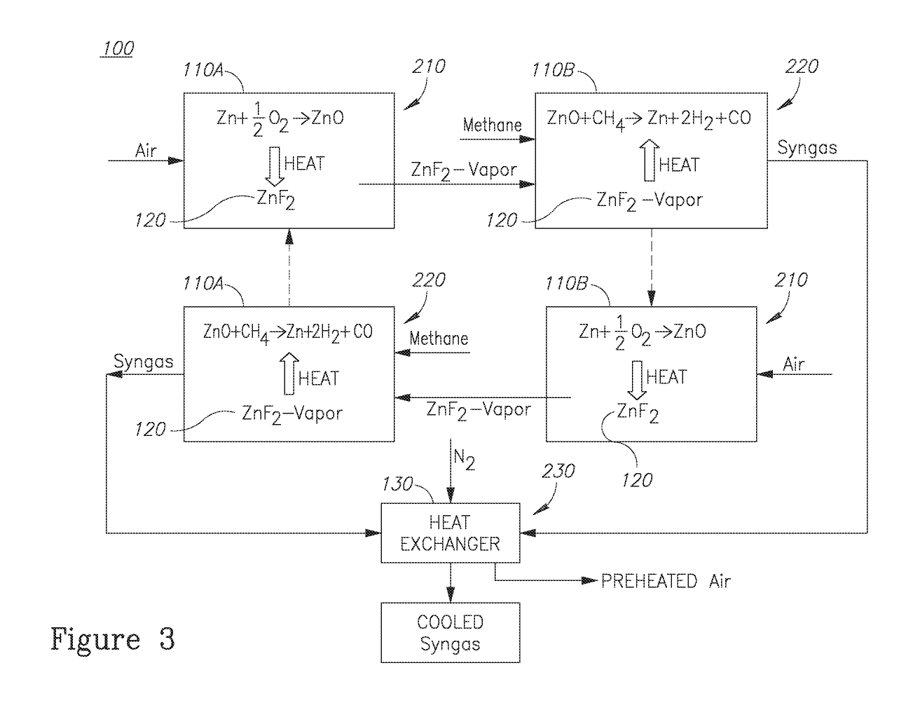

For example, syngas production unit 100 may comprise at least one reaction chamber 110 associated with at least one heat storage element 120. At least one first reaction chamber 110 is configured to enable zinc oxidation by introduced oxygen (step 210 in FIGS. 1A-1C, 2 and 3) and zinc oxide reduction by introduced methane (step 220 in FIGS. 1A-1C, 2 and 3), within at least one first reaction chamber 110. Steps 210, 220 may be carried out alternatingly in a single chamber, simultaneously in a single chamber or in separate chambers. FIGS. 1A-1C schematically illustrates embodiments in which single chamber 110 is used for the reaction, while FIGS. 2 and 3 schematically illustrates embodiments in which two chambers 110A, 110B are used to carry out the reaction, repeatedly alternating their roles as explained below. It is noted that FIG. 1A-1C and 2-3 illustrate one and two reaction chambers (110 and 110A, 110B, respectively) for illustrative purposes, while any number of reaction chambers 110 may be used to carry out the reactions. FIG. 1C schematically illustrates a chamber configuration in which both processes 210, 220 are carried out simultaneously in different compartments of chamber 110, with heat storage 120 mediating heat transfer therebetween. In certain embodiments, respective reactants are continuously introducing into two compartments of single chamber 110.

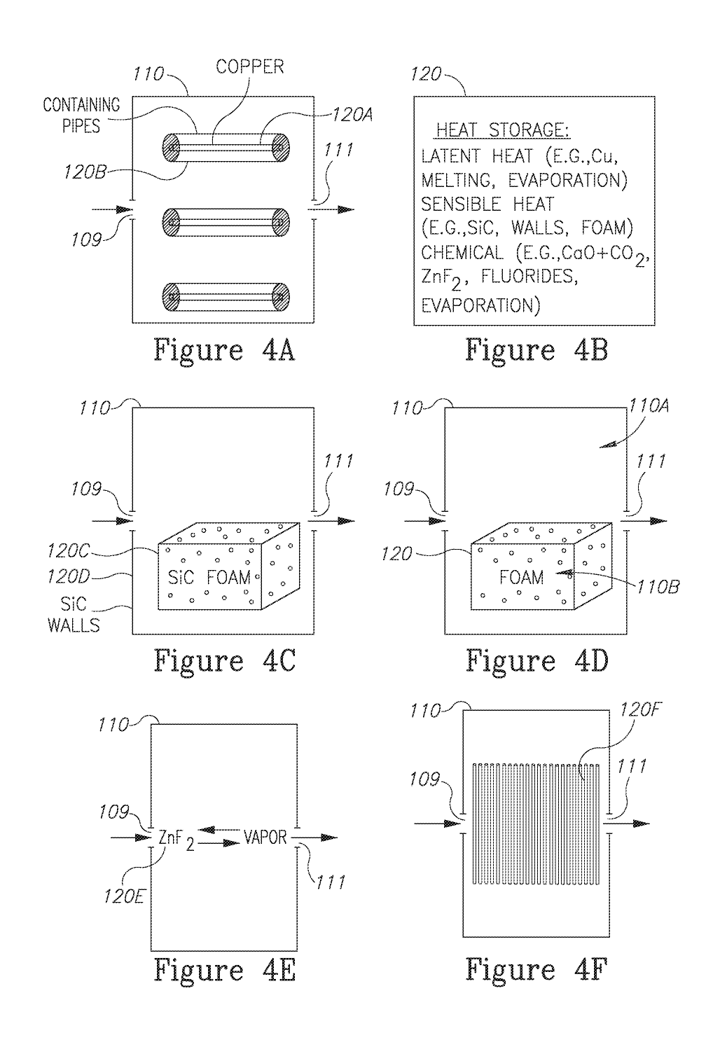

At least one heat storage element 120 may be configured to store heat produced by the oxidation of zinc (step 210) in at least one first reaction chamber 110 and supply the stored heat to the zinc oxide reduction with methane (step 220). FIGS. 4A-4F present high level schematic diagrams of exemplary heat storage elements 120, according to some embodiments of the invention, as explained below.

At least one second reaction chamber may be configured to enable cooling of syngas produced by the zinc oxide reduction by introduced methane and zinc regeneration from the zinc oxide reduction. Syngas cooling and zinc regeneration are illustrated as step 230 in FIGS. 1A, 1B, 2 and 3, and may be carried out in a dedicated chamber 130 (FIG. 1A, 1B) and/or in reaction chamber 110A, 110B acting as cooling and regeneration chamber in embodiments in which reaction chambers 110A, 110B repeatedly alternate roles, as explained below. Hence, the term “at least one second reaction chamber” as used in the application may be identical to or separate from the at least one first reaction chamber, depending upon implementation details. It is noted that while the at least one second reaction chamber is denoted by numeral 130 when not arranged to function as the at least one first reaction chamber and by numerals 110A, 110B when the process is carried out alternately in different first reaction chambers 110A, 110B, the different numerals are not to be understood as limiting the identity of the at least one second reaction chamber. Certain embodiments may comprise implementation of the at least one second reaction chamber in parts of unit 100 as at least one second reaction chamber 110A, 110B and in other parts as separate at least one second reaction chamber 130. Unit 100 may comprise two or more groups of reaction chambers 110 which reciprocate in their roles as carrying out steps 210, 220 and carrying out step 230, respectively.

FIG. 1C schematically illustrates reaction chamber 110 configured to carry out steps 210, 220 simultaneously and continuously. Reaction chamber 110 may be divided into two parts, the first part (illustrated in a non-limiting manner as the chamber's upper part) receives continuous oxygen injection (e.g., as air) and the second part (illustrated in a non-limiting manner as the chamber's lower part) receives continuous methane injection. In order to exploit the heat released by the oxygen-zinc reaction (step 210) for generating reaction between the methane and the zinc oxide, heat storing elements 120, e.g., a vertical pipe array containing heat storage material (like zinc fluoride or lithium) may be placed to cross the barrier between the two parts.

Syngas production unit 100 may further comprises a control unit 140 arranged to introduce oxygen into at least one first reaction chamber 110 to react with zinc therewithin (step 210), introduce methane into at least one first reaction chamber 110 to react with zinc oxide therewithin (step 220), and regulate the syngas cooling and the zinc regeneration (step 230) with respect to zinc oxidation and zinc oxide reduction processes (steps 210, 220, respectively).

Chambers 110, 130 may further comprise openings 109, 111 (see FIGS. 4A-4F) for introducing and removing gases, liquid and/or solids according to the illustrated reaction principles (e.g., oxygen and/or air introduction, nitrogen removal, zinc introduction, regenerated zinc introduction, methane introduction, syngas removal and introduction, heat storage material introduction and removal, etc.). Openings 109, 111 may be equipped with filters (e.g., particle filters) for controlling material flow through unit 100. Unit 100 may further comprise appropriate pipework, valves, heat exchangers and auxiliary devices for supporting the reactions and enhancing the efficiency of the process. In this context it is noted that in FIGS. 1A-1C, 2 and 3, solid lines represent material transfer which may be implemented by respective appropriate pipework, valves and openings, while broken lines represent changes in process steps that are carried out within the same chamber, including role changes as explained below.

Without wishing to be bound by theory, the heat released in the exothermic zinc oxidation reaction is used to enable and perform the endothermic syngas production reaction (i.e., zinc oxide reduction by methane). For example, under certain reaction conditions (e.g., in the temperature range 950° C.-1050° C.) exothermic oxidation of zinc (Zn+½O₂→ZnO, step 210) may release 350 kJ/mol while endothermic zinc oxide reduction (ZnO+CH₄→Zn+2H₂+CO, step 220) may require 317 kJ/mol, making the overall reaction exothermic (releasing 33 kJ/mol). Similar enthalpy differences (20-40 kJ/mol) are illustrated in Table 1 for a range of operation temperatures. Table 1 presents the changes in the system's enthalpy in the two reactions, as depending on temperature.

TABLE 1
Temperature dependency of system enthalpy changes

| | Zn + ½O₂(g)→ | ZnO + CH₄(g) → |
|---|---|---|
| | ZnO (step 210) | CO(g) + 2H₂(g) + Zn (step 220) |
| T (° C.) | ΔH (kJ/mol) | ΔH (kJ/mol) |
| 0 | −348.3 | 311.4 |
| 100 | −348.1 | 314.8 |
| 200 | −347.8 | 317.5 |
| 300 | −347.4 | 319.5 |
| 400 | −347.1 | 321.1 |
| 500 | −354.2 | 329.7 |
| 600 | −354.0 | 330.4 |
| 700 | −353.7 | 330.7 |
| 800 | −353.4 | 330.5 |
| 900 | −353.0 | 330.0 |
| 1000 | −352.5 | 329.2 |
| 1100 | −352.0 | 328.0 |
| 1200 | −351.4 | 326.6 |
| 1300 | −350.8 | 325.0 |
| 1400 | −350.1 | 323.1 |
| 1500 | −349.3 | 321.0 |

The overall released energy may be used for heating and/or for compensating losses in the process. The energy may be returned to the system by heating the introduced air and/or methane, with respective process adaptations. In certain embodiments, method 200 and unit 100 are operated under conditions in which the heat released by the zinc oxidation is at least as large as the heat used for the zinc oxide reduction. In certain embodiments, a small energy deficit may be compensated by an external energy source or by oxidizing a surplus of zinc with respect to the amount of reduced zinc oxide.

FIGS. 1A and 1B schematically illustrate embodiments in which at least one second reaction chamber 130 is separate from at least one first reaction chamber 110 and control unit 140 is further arranged to introduce the regenerated zinc into at least one first reaction chamber 110. While control unit 140 is illustrated schematically, the present invention comprises proper configuration of control unit 140 in the embodiments to monitor and control material and heat flows through system 100. FIG. 1B illustrates unit 100 in some more details, showing particle filters 125A, 125B (or other cleaning unit(s) such as porous ceramic media, electrostatic precipitators and/or scrubbers) configured to remove particles from the exiting nitrogen and syngas (respectively; particle filters 125A, 125B may be separate or identical), and heat exchangers 130A, 130B configured to cool the syngas (130A) and to transfer the heat from the exiting nitrogen and/or syngas to the introduced air and/or methane (130B). Heat exchangers 130A, 130B may be separate, identical and/or multiple, and generally arranged according to specified heat regeneration and use requirements (represented by the broken connecting line). Heat exchanger 130B may receive combined or separate feeds of air or oxygen, and methane, and may have an outlet for nitrogen. Heat from outflowing nitrogen (of step 210) may be recuperated and used to heat incoming flows. Gas and heat flows may be monitored and controlled by control unit 140. In certain embodiment, when using foam (e.g., SiC foam) as at least part of heat storage 120 (see e.g., FIGS. 4A-4F), foam 120 may be configured to enhance the distribution of the reactants so that reactant may be injected simultaneously into single chamber 110 after reaching the required temperature via the exothermic reaction. The foam may be configured to spatially separate the oxidation of zinc and the reduction of the zinc oxide to enable carrying them out simultaneously.

FIG. 1C schematically illustrates a chamber configuration in which both processes 210, 220 are carried out simultaneously in different regions of chamber 110, with heat storage 120 mediating heat transfer therebetween. As above, particle removal device 125 may represent one or more cleaning units 125.

Certain embodiments comprise syngas production unit 100 comprising a single chamber 110 comprising a first section for oxidizing zinc (step 210), a second section for reducing the produced zinc oxide with methane (step 220), and an intermediate section comprising heat storage element(s) 120 configured to receive zinc oxidation heat from the first section and to provide the received heat for the zinc oxide reduction in the second section, wherein the oxidation and reduction are carried out simultaneously in the respective sections. Syngas production unit 100 may further comprising control unit 140 configured to regulate flows of air or oxygen into the first section, nitrogen out of the first section, methane into the second section and syngas out of the second section. Syngas production unit 100 may further comprise at least one particle removal device 125 configured to remove zinc oxide particles from the nitrogen flow and deliver the particles into the second section. Heat storage element(s) may comprise a plurality of vertical metal pipes containing at least one fluoride. The first section may be in the upper part of chamber 110 and the second section may be in the lower part of chamber 110. In general, the first section and the second section may be oriented spatially in any chosen configuration.

FIG. 2 schematically illustrates at least one first reaction chamber 110A and at least one second reaction chamber 110B being arranged to enable both (a) zinc oxidation and zinc oxide reduction (step 210) and (b) zinc regeneration and syngas cooling (step 220). Control unit 140 is arranged to repeatedly alternate roles of at least one first and second chambers 110A, 110B (respectively) to carry out consequent zinc oxidation and zinc oxide reduction (steps 210, 220) in at least one chamber 110A, 110B in which zinc regeneration (step 230) was carried out last. In certain embodiments, chambers 110 may comprise at least two groups 110A, 110B of reaction chambers, operating simultaneously and reciprocally to carry out reaction steps 210, 220 and reaction step 230 respectively.

In certain embodiments (not illustrated), at least one second reaction chamber 130 is at least one first reaction chamber 110, that is, syngas production unit 100 is configured to perform the syngas cooling and the zinc regeneration within at least one first reaction chamber 110.

FIG. 3 schematically illustrates syngas generation system 100, according to some embodiments of the invention. FIG. 3 illustrates an example of two (sets) of reaction chambers 110A and 110B, operating reciprocally to carry out zinc oxidation 210 and zinc oxide reduction 220. In the illustrates example, zinc fluoride (ZnF₂) is used as heat storage material 120 which is transferred from the chamber in which zinc oxidation 210 is carried out to the chamber in which zinc oxide reduction is carried out (110A to 110B in the top part of FIG. 3, 110B to 110A in the middle part of FIG. 3) Zinc fluoride (ZnF₂) may be chosen as at least a part of heat storage material 120 due to zinc being a reactant in steps 210 and 220, and due to its high boiling point and high evaporation heat, which allows using evaporation heat to transfer energy from zinc oxidation 210 to zinc oxide reduction 220 under the reaction conditions. In certain embodiments, zinc and zinc fluoride in one chamber (110A or 110B) may be ignited in air to evaporate the zinc fluoride salt. The vapor may be transferred to the other chamber (110B, 110A, respectively) holding zinc oxide and methane. Upon introduction of the hot ZnF₂ vapor the methane reduces the zinc oxide to generate syngas, and leave behind zinc and cooled ZnF₂, which may be ignited in air to reiterate the processes with chambers 110A, 110B switching their roles. Alternatively or complementary, a cascade of chamber and/or a single chamber may be arranged to carry out the consecutive reaction steps 210, 220 according to the illustrated principles. In certain embodiments, zinc may be used as heat storage material 120 in place or additionally to zinc fluoride and/or any other heat storage element 120. In such embodiments, regulating the amount of zinc provides simultaneous control of both the syngas production process and the extent of heat storage.

FIGS. 4A-4F are high level schematic illustrations of heat storage elements 120 and methods, according to some embodiments of the invention. The various schematic illustrations in FIGS. 4A-4F denote different but possibly complementary configurations of heat storage elements 120 and methods. As illustrated schematically in FIG. 4B, heat storage may be carried out by any of latent heat storage, sensible heat storage and chemical energy storage as well as by any of their combinations. Appropriate materials are selected with respect to the conditions of zinc oxidation and zinc oxide reduction reactions 210, 220 respectively.

Heat storage may be carried out by providing chamber 110 with heat storage elements 130 comprising any of at least one first material selected to change phase upon the heat storing; at least one second material selected to heat up upon the heat storing; and at least one third material selected to undergo a specified reversible chemical reaction upon the heat storing.

For example, within the temperature range of 950° C.-1100° C., the at least one first material, storing heat by phase change, may be a metal or a metal alloy, such as copper (melting point 1084°). In another example heat storage may be carried out within the range 950° C.-1420° C., using for example copper and silicon, and their respective alloys (silicon melting point 1411° C.). In another example, fluorides salts of magnesium and/or mixed fluorides salts with alkali metals may be used. In certain embodiments, a combination of magnesium fluoride and calcium fluoride may be used for preventing the creation of large crystals that may damage the pipe/wall casing. The at least one first material may be enclosed within basins, as ampules and/or pipes 120B (FIG. 4A) and/or a ceramic casing that support the liquid phase thereof and promotes heat exchange of the at least one first material with the volume of chamber 110 in which zinc oxidation and zinc oxide reduction reactions take place.

In another example, the at least one second material may comprise silicon carbide and may be applied as a structural element 120D of chamber 110 and/or as a separate member such as silicon carbide foam 120C within chamber 110 (FIG. 4C). Metal zinc may be placed in reactor chamber 110. A controlled amount of hot air may be introduced into chamber 110 (via opening 109), the zinc may then be ignited, and the nitrogen released through a particle filter (via opening 111) into a heat exchanger 130. The zinc oxide is accumulated in reactor chamber 110 during the oxidation reaction. After a designed temperature rise is achieved, nitrogen outlet 111 and air inlet 109 may be blocked and methane may be introduced into chamber (via opening 109 which may be the same or different from air inlet 109). Then, syngas is produced by the reaction between the methane and the accumulated hot zinc oxide using the heat stored in chamber 110 and/or heat storage elements 120.

The produced syngas may be released through a heat exchanger such as chamber 130. In this step the zinc vapor may be condensed and returned to reactor chamber 110. The process may be repeated—air may be introduced into reactor chamber 110, the regenerated zinc may be ignited and burnt, heat is accumulated in heat storage elements 120, nitrogen released, and so forth to complete a further cycle and produce a next amount of syngas. In certain embodiments, using a foam as heat storage elements 120, the foam may be used to enhance the distribution of the reactants to the extent that they may be injected simultaneously into a single chamber 110 (after reaching the required temperature via the exothermic reaction). FIG. 4D schematically illustrates foam 120 separating single chamber 110 into at least two compartments 110A, 110B, in which different reactions may take place simultaneously, e.g., step 210 (oxidation of zinc) in compartment 110A and step 220 (reduction of zinc oxide) in compartment 110B (or vice versa).

In certain embodiments, vertical metal pipes 120F may be used as heat storage elements 120 (FIG. 4F). Vertical metal pipes 120F may be configured to enhance the heat transfer from the gaseous environment to the heat storage materials (for the exothermic case, step 210) and from the heat storage material to the gaseous environment (for the endothermic case, step 220). Pipe arrays 120F may be arranged in a design that optimizes the heat transfer between the involved materials. In certain embodiments, the pipe casing may have a high surface to volume ratio and the pipe shapes may be selected respectively. As a non-limiting example, in certain embodiments the inventors have calculated the following configuration. In order to produce four tons of syngas per day, 3525 kg of magnesium fluoride as heat storage material 120 are required, the number of cylindrical pipes 120F needed is 784 wherein the inner diameter of each cylindrical pipe is 3 cm, the outer diameter is 4 cm and the length of each pipe is 2 m. With this configuration, the overall process may be conducted separately with the endothermic reaction (reduction process, step 220) being operated after the exothermic reaction (combustion process, step 210) ends. In such cases the combustion time lasts 140 sec and the reduction time is 225 sec. The amount of zinc required for this process is 133 kg. In any other configuration specific design and material flow details may be adapted to enhance efficiency.

The at least one first material may comprise fluoride salts, magnesium fluoride and calcium fluoride which are mixed to prevent growing of large crystals, to avoid impact on the at least one second material. In certain embodiments, different ratios of magnesium fluoride to calcium fluoride may be used to configure the operation temperature of the process, or may be selected according to specified required operation temperature. For example, applying a temperature range of 1000° C. to 1200° C., a mixture of 81.3% wt. magnesium fluoride and 18.7% wt. of calcium fluoride is required for the lowest temperature while for the highest temperature 93.8% wt. of magnesium fluoride and 6.2% wt. of calcium fluoride is needed. The weight ratio of magnesium fluoride and calcium fluoride may range between 80:20 and 95:5.

Latent and sensible heat storage by first and second materials (respectively) may be combined, e.g., first material such as copper may be stored within a casing made of the second material such as silicon carbide, to thus enhance the efficiency and capacity of heat storage. In a non-limiting example, copper may be used as the phase change first material and silicon carbide may be used as the protective second material which absorbed additional heat. For example, heat storage elements 120 may comprise copper rods which are encapsulated in silicon carbide tubes. The encapsulated rods may be placed in a silicon carbide reactor together with zinc. Hence, chamber structural material 120D (e.g., chamber walls), casing 120B and copper 120A in the casing are all heat storage elements 120 (FIG. 4A). In certain embodiments, silicon may be used as heat storing material. In certain embodiments, graphite or combinations of graphite and ceramic materials may be used to isolate melting copper (or silicon) from surrounding containers such as pipes (e.g., silicon carbide pipes) in order to avoid damage (e.g., corrosion) to the respective containers. For example, heat storage elements 120 may comprise ceramic pipes (made, e.g., of silicon carbide) which enclose graphite pipes that hold heat storage material such as fluoride salts.

After ignition of the zinc, air is introduced until sufficient heat to melt the copper is obtained, and then nitrogen is released through a valve equipped with a particles filter. When the oxidation stage is completed, the nitrogen release valve is closed, introduction of air is stopped and methane is introduced to produce syngas by the reaction with the zinc oxide and using the heat stored by the phase change material 120A, 120B, 120D. The syngas may then be cooled down by a heat exchanger such as chamber 130, condensing the zinc vapor. At the end of this stage the process may be repeated. Heat may be recuperated from either or both nitrogen and syngas to sustain the cyclicality of the reactions with minimal or no addition of energy. The amounts of the reactants may also be adjusted to maintain a specified energy balance of the process.

In order to obtain continuous operation, two identical reactor chambers 110A, 110B may be connected in parallel. While syngas is produced in one reactor 110A, the produced hot syngas may be transported to second reactor 110B (operating as chamber 130) for cooling and condensing the zinc. After this stage is completed, the accumulated zinc (in second chamber 110B) is ignited, and air is introduced, methane is introduced and the hot syngas is transported back to first reactor chamber 110A, where it is cooled and the zinc is condensed. This cascade process is repeated continuously.

In certain embodiments, zinc fluoride 120E may be used for energy storage, being a salt with a high boiling point, high evaporation heat and zinc-based (FIG. 4E). Certain embodiments comprise using any of various salts which are used for heat storage (usually storing heat by melting the salt), such as fluoride salts of alkali metals and alkaline earth metals such as magnesium, potassium, sodium, calcium, lithium, and their compounds and mixtures, as listed in detail e.g., in Misra and Whittenbereer 1987: “Fluoride salts and container materials for thermal energy storage application in the temperature range 973 to 1400K”, NASA technical memorandum 89913, AIAA-87-9226. In certain embodiments, CeF₃ may be used with MgF₂ to enhance heat storage. Reaction chambers 110 may be made of material detailed in this report, and structural chamber parts may participate in the heat storage as sensible heat storage materials. Any combination of the heat storage methods described above may be configured to be applied in the present invention.

In yet another example, the at least one third material may comprise calcium oxide which may be reversibly and cyclically reacted with CO₂ to store zinc oxidation reaction heat.

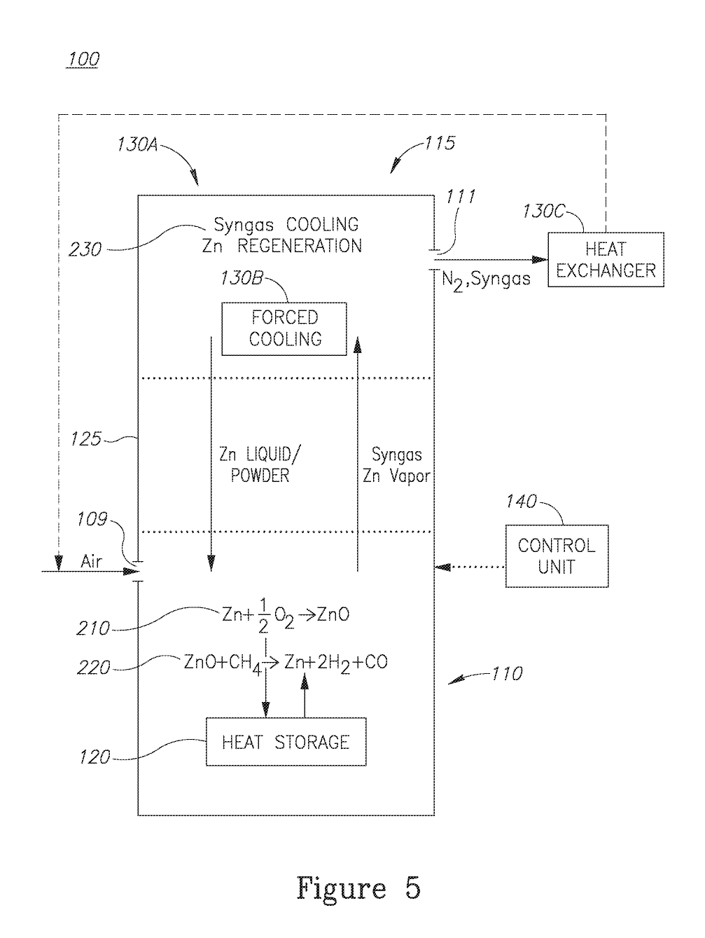

FIG. 5 is a high level schematic illustration of syngas production system 100, according to some embodiments of the invention. System 100 comprises a vertical chamber 115 comprising at least one reaction chamber 110 in which zinc oxidation, oxidation heat storage and consequent zinc oxide reduction are carried out. Produced syngas as well as (optionally) nitrogen from introduced air and zinc vapor rise through an intermediate section 125 to at least one cooling chamber 130A in which syngas is cooled and zinc is regenerated. Regenerated zinc may be allowed to return to chamber 110 through intermediate section 125. At least one cooling chamber 130A may comprise respective forced cooling heat exchanger(s) 130B arranged to quickly cool the rising gases and vapor and to cool the zinc vapors to an extent that enables their returning to chamber 110 (e.g., by gravitation), without the condensed or the deposited vapors getting caught in intermediate chamber 125. The forced cooling in heat exchanger(s) 130B may be carried out by respective thermic means, for example by a thermal fluid (liquid or gas). The extracted heat may be used throughout system 100 (e.g., to pre-heat the introduced air) or externally. Additional heat may be extracted from nitrogen and/or syngas exiting cooling chamber 130A by a heat exchanger 130C, and the heat may be used to preheat introduced air and/or methane.

Intermediate chamber 125 may be arranged to quench the hot zinc vapor and to withstand the thermal and pressure gradients between chambers 110 and 130A. For example, chamber 110 may operate at 1000±150° C. and chamber 130A may operate at between 450-600° C., and intermediate chamber 125 may be arranged to withstand the respective thermal gradient. Intermediate chamber 125 may be further arranged to prevent premature solidification or to maintain a particle size of zinc particles below a specified threshold, allowing zinc to enter reaction step 210 in chamber 110.

In certain embodiments, vertical chamber 115 comprises lower reaction chamber 110 in which zinc oxidation is carried out by introduced oxygen and zinc oxide reduction is carried out by introduced methane to produce syngas, wherein heat from the zinc oxidation is stored and released to drive the zinc oxide reduction, an upper cooling chamber 130 in which the produced syngas is cooled and from which residual zinc is returned to the lower reaction chamber, and an intermediate section 125 configured to connect lower and upper chambers 110, 130 (respectively) and withstand thermal and pressure gradients therebetween. Zinc fluoride may be used to store and release the heat.

When using zinc fluoride or any other evaporating material as heat storage element 120, pure oxygen may be supplied to oxidize the zinc in order to avoid the need to remove gases (such as nitrogen) from reaction chamber 110, and thus avoid the need to separate zinc fluoride or other vapors from the removed gases.

In certain embodiments, which may be applied to any of the above, zinc may be used as at least a part of heat storage element 120. Heat storage in zinc may be used to reduce the number of elements in the process and possibly simplify the process. Operation under reduced temperatures may be necessary as zinc evaporates at 907° C. under standard conditions. Use of zinc as heat storage element 120 may enhance the safety of system 100.

FIG. 6 is a high level flowchart illustrating method 200, according to some embodiments of the invention. Method 200 may comprise any of the following stages: Oxidizing zinc to generate heat (stage 210), generating syngas from the methane, thereby de-oxidizing, i.e., reducing the zinc oxide (stage 220) and cooling the syngas (stage 230).

Oxidizing zinc to generate heat (stage 210) may comprise any of using air to oxidize zinc and removing the nitrogen (stage 212), storing the oxidation heat (stage 216) and using latent heat storage and/or sensible heat storage and/or chemical heat storage (stage 217). Reducing the zinc oxide (stage 220) may comprise any of introducing methane to the oxidized zinc (stage 222), optionally preheating the methane (stage 221) and using the stored heat to produce the syngas (stage 224). Method 200 may further comprise regenerating zinc from the de-oxidized (reduced) zinc oxide (stage 232). Regenerating the reduced zinc may be carried out during cooling of the syngas and method 200 may further comprise introducing the regenerated zinc into the vessel used for the zinc oxidation (stage 250).

Certain embodiments may comprise any of removing nitrogen through a particle filter (stage 213), heating the introduced air using heat from the nitrogen and or the syngas (stage 214), and/or using heat from outflowing nitrogen to heat introduced gases (stage 215).

In certain embodiments, method 200 may be configured to be carried out in a single chamber by alternating zinc oxidation and zinc oxide reduction processes (stage 240). The oxidation and the regeneration may be carried out in a first chamber, and method 200 may further comprise carrying out the regeneration in a second chamber, and carrying out consequent zinc oxidation and zinc oxide reduction in the second chamber. In certain embodiments, method 200 may comprise using, reciprocally, one vessel for the zinc oxidation and the syngas generation, and another vessel for cooling the syngas and regenerating the zinc (stage 260). Method 200 may comprise repeatedly alternating roles of a first chamber and a second chamber between (a) zinc oxidation and zinc oxide reduction and (b) zinc regeneration and syngas cooling, wherein consequent zinc oxidation and zinc oxide reduction is carried out in the chamber in which the zinc regeneration was carried out last.

Method 200 may further comprise any of the following stages: using a vertical vessel having a lower reaction chamber and an upper cooling chamber, separated by an intermediate section (stage 290), configuring the intermediate section to quench rising gas and vapor (stage 292), force-cooling gas and vapor in the upper cooling chamber (stage 294), configuring the intermediate section to withstand thermal and pressure gradients between the lower and upper chambers (stage 296) and controlling the processes to re-introduced regenerated zinc from the cooling chamber into the reaction chamber (stage 298).

In certain embodiments, method 200 comprises storing heat produced by oxidation of zinc in evaporating zinc fluoride; using the stored heat to react the produced zinc oxide with methane to form syngas and to condense the zinc fluoride vapors and cooling the syngas and residual zinc vapors to re-use the residual zinc. Method 200 may carrying out the oxidation (step 210) and the reduction (step 220) simultaneously (stage 300) and spatially separating the simultaneous oxidation and reduction (stage 305), e.g., using foam for heat storage and configuring the foam to spatially separate the oxidation of zinc and the reduction of the zinc oxide to enable carrying them out simultaneously (stage 310). For example, method 200 may further comprise carrying out the oxidation of zinc and the reaction of the produced zinc oxide with methane in a first section of single chamber and carrying out the cooling of the syngas in a second section of the single chamber and configuring an intermediate section of the single chamber to withstand thermal and pressure gradients between the first and the second chamber sections. Method 200 may comprise designing the heat exchanger's capacity to effectively support the simultaneous process for a given throughput (stage 320).

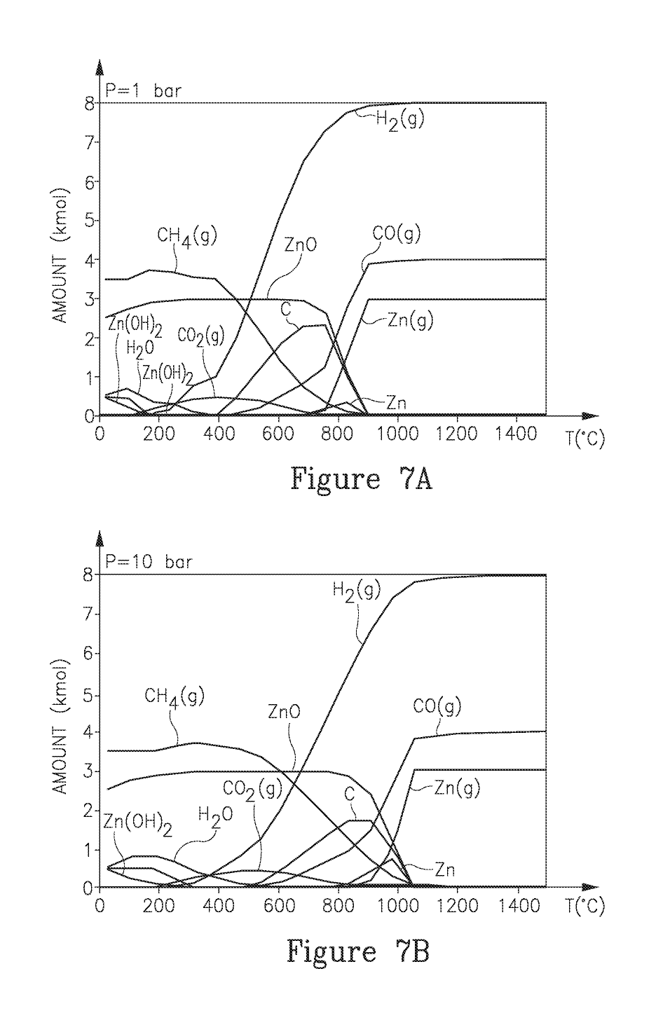

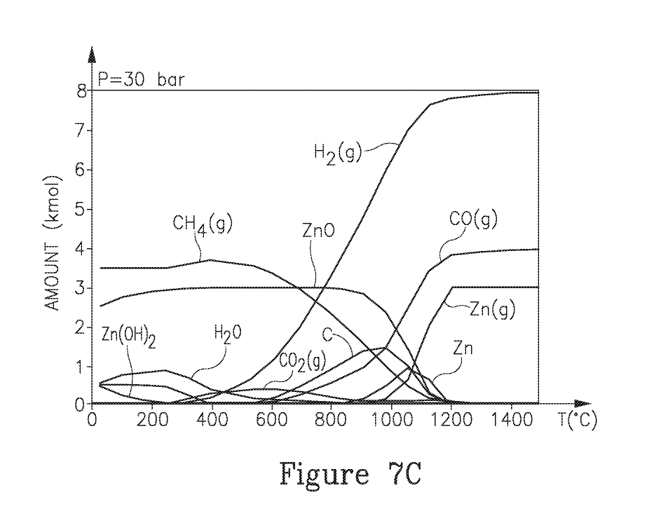

FIGS. 7A-7C are illustrative thermodynamic diagrams illustrating reaction conditions for converting methane to syngas, according to some embodiments of the invention. FIGS. 7A, 7B and 7C illustrate the amounts of reactants and products depending on the temperature, at pressures of 1, 10 and 30 bar, respectively. The methane to syngas conversion temperatures rises with rising pressure. In certain embodiments, the reactions may be carried out under even larger pressures, such as 50 bar. Carrying out the reaction under elevated pressure may be advantageous in processes which convert the produced syngas to fuel at high pressures (reaching e.g., 70 bar). In such cases, pressurization at the syngas production stage may prove beneficial in the overall energy balance of the process as a whole. The reaction chambers and associated equipment may be arranged to withstand the respective pressures. Any of the embodiments presented above and in the figures may be adapted respectively to operate under specified high pressures, e.g., 10 bar, 30 bar, 50 bar etc. Any of the embodiments presented above and in the figures may be adapted respectively to operate under specified temperature ranges, e.g., around 900° C., around 1100° C., around 1300° C. or at specific ranges according to specific system designs.

Advantageously, the cyclic steps of zinc oxidation and reduction of zinc oxide combine an exothermic heat delivering step with an endothermic syngas production step, respectively, both using zinc as the pivotal element that enables the process to be carried out cyclically. Heat is delivered from the exothermic step to the endothermic syngas via heat storage elements of various types which are arranged according to the reaction's conditions and characteristic temperatures.

In the above description, an embodiment is an example or implementation of the invention. The various appearances of “one embodiment”, “an embodiment”, “certain embodiments” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Certain embodiments of the invention may include features from different embodiments disclosed above, and certain embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
storing heat produced by oxidation of zinc;
using the stored heat to react the produced zinc oxide with methane to form syngas; and
re-using zinc reduced by the reaction with methane for the oxidation,
wherein the oxidation of zinc and the reduction of the zinc oxide carried out cyclically, to yield syngas continuously.

2. The method of claims 1, further comprising carrying out the oxidation of zinc and the reaction of the produced zinc oxide with methane continuously in a single chamber.

3. The method of claim 1 or 2, wherein the exothermic oxidation of zinc and the endothermic reduction of zinc are carried out under conditions in which the heat released by the zinc oxidation is at least as large as the heat used for the zinc oxide reduction.

4. The method of any one of claims 1-3, configured to be carried out in a single chamber by alternating zinc oxidation and zinc oxide reduction processes.

5. The method of any one of claims 1-4, further comprising regenerating the reduced zinc during cooling of the syngas.

6. The method of claim 5, wherein the oxidation and regeneration are carried out in a first chamber, the method further comprising carrying out the regeneration in a second chamber, and carrying out consequent zinc oxidation and zinc oxide reduction in the second chamber.

7. The method of claim 5, further comprising repeatedly alternating roles of a first chamber and a second chamber between (a) zinc oxidation and zinc oxide reduction and (b) zinc regeneration and syngas cooling, wherein consequent zinc oxidation and zinc oxide reduction is carried out in the chamber in which the zinc regeneration was carried out last.

8. The method of any one of claims 1-7, wherein the storing is carried out by at least one of: latent heat storage, sensible heat storage and chemical energy storage.

9. The method of any one of claims 1-7, wherein the storing is carried out by providing a chamber in which the zinc oxidation and zinc oxide reduction are carried out with at least one of: at least one first material selected to change phase upon the heat storing at least one second material selected to heat up upon the heat storing; and at least one third material selected to undergo a specified reversible chemical reaction upon the heat storing.

10. The method of claim 9, wherein the at least one first material is at least one of: copper, copper alloys, silicon, silicon alloys, silicon carbide, silicon carbide foam, zinc, zinc fluoride, lithium, fluorides salts of magnesium, fluorides salts of calcium, fluorides salts of alkali metals, fluoride salts of alkaline earth metals and mixtures thereof; the at least one second material is at least one of: silicon carbide, graphite, a combination of graphite and ceramic materials, silicon and silicon alloys; and the at least one third material is zinc fluoride.

11. The method of claim 9, wherein the at least one first material comprises a foam configured to spatially separate the oxidation of zinc and the reduction of the zinc oxide to enable carrying them out simultaneously in a single reaction chamber.

12. The method of claim 9, wherein the at least one first material comprises fluoride salts, magnesium fluoride and calcium fluoride which are mixed to prevent growing of large crystals, to avoid impact on the at least one second material.

13. The method of claim 12, wherein the at least one first material comprises magnesium fluoride and calcium fluoride at weight ratios between 80:20 and 95:5.

14. The method of any one of claims 1-13, wherein the heat storing is carried out in evaporating zinc fluoride or zinc, and further comprising cooling the syngas and residual zinc vapors to re-use the residual zinc.

15. The method of claim 14, further comprising carrying out the oxidation of zinc and the reaction of the produced zinc oxide with methane in a lower section of a single chamber and carrying out the cooling of the syngas in an upper section of the single chamber, and configuring an intermediate section of the single chamber to withstand thermal and pressure gradients between the lower and upper chamber sections.

16. The method of claim 15, further comprising carrying out the oxidation of zinc in a first section of the single chamber and carrying out the reaction of the produced zinc oxide with methane in a second section of the single chamber, and configuring an intermediate section of the single chamber to withstand thermal and pressure gradients between the first and the second chamber sections.

17. The method of claim 16, wherein the storing the produced heat and the using the stored heat are carried out in the intermediate section.

18. The method of claim 17, further comprising designing the intermediate section to comprise a plurality of metal pipes containing at least one fluoride.

19. The method of any one of claims 1-18, wherein the oxidation of zinc is carried out by supplying air and removing heated nitrogen via a heat exchanger to heat the supplied air.

20. The method any one of claims 1-19, wherein the oxidation of zinc is carried out by pure oxygen.

21. A syngas production unit comprising:
a single chamber comprising:
a first section arranged for oxidizing zinc,
a second section arranged for reducing the produced zinc oxide with methane, and
an intermediate section comprising a plurality of heat storage pipes configured to receive zinc oxidation heat from the first section and to provide the received heat for the zinc oxide reduction in the second section,
wherein the oxidation and reduction are carried out simultaneously in the respective sections.

22. The syngas production unit of claim 21, further comprising a control unit configured to regulate flows of air or oxygen into the first section, nitrogen out of the first section, methane into the second section and syngas out of the second section.

23. The syngas production unit of claim 22, further comprising at least one particle removal device configured to remove zinc oxide particles from the nitrogen flow and deliver the particles into the second section.

24. The syngas production unit of any one of claims 21-23, wherein the plurality of heat storage pipes contains at least one fluoride.

25. A syngas production unit comprising at least one reaction chamber associated with at least one heat storage element,
wherein:
at least one first reaction chamber is configured to enable zinc oxidation by introduced oxygen and zinc oxide reduction by introduced methane, within the at least one first reaction chamber,
the at least one heat storage element is configured to store heat produced by the oxidation of zinc in the at least one first reaction chamber and supply the stored heat to the zinc oxide reduction with methane,
at least one second reaction chamber is configured to enable cooling of syngas produced by the zinc oxide reduction by introduced methane and zinc regeneration from the zinc oxide reduction,
the oxidation of zinc and the reduction of the zinc oxide are carried out cyclically, to yield syngas continuously, and
the syngas production unit further comprises a control unit arranged to introduce oxygen into the at least one first reaction chamber to react with zinc therewithin, introduce methane into the at least one first reaction chamber to react with zinc oxide therewithin, and regulate the syngas cooling and the zinc regeneration with respect to the zinc oxidation and the zinc oxide reduction processes.

26. The syngas production unit of claim 25, wherein the at least one second reaction chamber is the at least one first reaction chamber and the syngas production unit is configured to perform the syngas cooling and the zinc regeneration within the at least one first reaction chamber.

27. The syngas production unit of claim 25, wherein the at least one second reaction chamber is separate from the at least one first reaction chamber and the control unit is further arranged to introduce the regenerated zinc into the at least one first reaction chamber.

28. The syngas production unit of claim 25, wherein the at least one first reaction chamber and the at least one second reaction chamber are arranged to enable both (a) zinc oxidation and zinc oxide reduction and (b) zinc regeneration and syngas cooling, and wherein the control unit is arranged to repeatedly alternate roles of the at least one first and second chambers to carry out consequent zinc oxidation and zinc oxide reduction in the at least one chamber in which the zinc regeneration was carried out last.

29. The syngas production unit of any one of claims 25-28, wherein the at least one heat storage element comprises at least one of: at least one first material selected to change phase upon the heat storing; at least one second material selected to heat up upon the heat storing; and at least one third material selected to undergo a specified reversible chemical reaction upon the heat storing.

30. The syngas production unit of any one of claims 25-28, wherein the at least one heat storage element comprises at least one of: copper, copper alloys, silicon, silicon alloys, silicon carbide, silicon carbide foam, zinc, zinc fluoride, fluorides salts of magnesium, fluoride salts of alkali metals, fluorides salts of alkaline earth metals and mixtures thereof.

31. The syngas production unit of any one of claims 25-28, wherein the at least one heat storage element comprises at least one of: walls of the at least one first reaction chamber and pipework containing heat storage material.

32. The syngas production unit of claim 31, wherein the at least one heat storage element comprises vertical pipes containing heat storage material.

33. The syngas production unit of any one of claims 25-32, wherein the at least one first reaction chamber is configured to enable zinc oxidation by supplying pre-heated air and is further configured to remove heated nitrogen via a heat exchanger to pre-heat at least one of the supplied air and the introduced methane.

34. The syngas production unit of any one of claims 25-33, wherein the oxidation of zinc is carried out by pure oxygen.

35. The syngas production unit of claim 25, wherein the oxidation of zinc and the reaction of the produced zinc oxide with methane are carried out simultaneously in a single reaction chamber.

36. The syngas production unit of claim 35, wherein the at least one heat storage element comprises a foam configured to spatially separate the oxidation of zinc and the reduction of the zinc oxide to enable carrying them out simultaneously in the single reaction chamber.

37. The syngas production unit of claim 35, wherein the single chamber comprises:
a first section for the oxidation of zinc,
a second section for the reaction of the produced zinc oxide with methane, and
an intermediate section configured to withstand thermal and pressure gradients between the first and the second chamber sections.

38. The syngas production unit of claim 37, wherein the intermediate section comprises the at least one heat storage element.

39. The syngas production unit of claim 38, wherein the at least one heat storage element comprises a plurality of vertical metal pipes containing at least one fluoride.

40. A vertical chamber comprising:
a lower reaction chamber in which zinc oxidation is carried out by introduced oxygen and zinc oxide reduction is carried out by introduced methane to produce syngas, wherein heat from the zinc oxidation is stored and released to drive the zinc oxide reduction,
an upper cooling chamber in which the produced syngas is cooled and from which residual zinc is returned to the lower reaction chamber, and
an intermediate section configured to connect the lower and upper chambers and withstand thermal and pressure gradients therebetween.

41. The vertical chamber of claim 40, wherein zinc fluoride or zinc are used to store and release the heat and wherein pure oxygen is used for zinc oxidation.
